(19) United States
(12) Patent Application Publication
(10) Pub. No.: US 2010/0176658 A1
(43) Pub. Date: Jul. 15, 2010

(54) Power Control Apparatus for Power Strip

(76) Inventor: Li-Chun LAI, Panciao City (TW)

Correspondence Address: HDLS IPR Services, PO Box 220746, Chantilly, VA, 20153, US

(21) Appl. No.: 12/352,661

(22) Filed: Jan. 13, 2009

(51) Int. Cl. H02J 3/00

(52) U.S. Cl. 307/39

(57) ABSTRACT

In a power control apparatus for a power strip, the power strip includes at least one power outlet being able to supply power when the power strip is empowered. Whether auxiliary power outlets are able to supply power is controlled by the control apparatus. The control apparatus includes a USB connector protruding outward the surface of the power strip, and the USB connector is able to be connected to a computer host, so as to make the signal lines of the USB connector able to receive signals from the computer host and to deliver the computer signals to a comparison circuit for being compared with a reference level through a signal isolation circuit and a filter circuit. Once the output signal of the filter circuit is lower than the reference level, the comparison circuit outputs the signal to the amplifier circuit for being amplified to drive the relay, so as to deliver the AC power to each power outlet of the power strip. Therefore the auxiliary power outlets of the power strip are able to supply power.

### BACKGROUND OF THE INVENTION

1. Field of the Invention

The present invention relates to a power control apparatus for a power strip. More particularly, the present invention relates to a power control apparatus for a power strip which is controlled to supply power via the power outlets of the power strip by the signals of a computer host.

2. Description of the Prior Art

One conventional power control apparatus for a power strip is disclosed in the U.S. Pat. No. 6,586,849 (hereinafter the cited patent) and is characterized in that “An electrical power strip that can be used in conjunction with a computer so as to allow peripheral devices associated with the computer to be automatically turned on or off simultaneous with the computer being turned on or off. The power strip preferably includes a USB connector that allows the power strip to be connected to the power source provided by the USB port of a computer. The power strip further includes a relay element that effectively energizes the power strip when the connected computer is turned on and de-energizes the power strip when the computer is turned off. Thus, the user can utilize the power strip to ensure that any peripheral devices plugged into the power strip are automatically turned off when the connected computer is turned off and turned on when the computer is turned on.”

Thus, the cited patent disclosed the technology that retrieves power of the computer host via the USB connector, through operation of the power controlled relay, to deliver the alternating current (AC) power to the auxiliary power outlets of the power strip. The power supply mode of the cited patent controlling the power strip by the output power of the computer host is disadvantaged in following drawbacks.

1. Since the power lines of USB connector are attached to the two ends of the USB connector, once the USB connector is impacted, the USB connector may be deformed and results in bad connection of the power lines. Therefore the power is unable to be delivered to the control apparatus and the power outlets of the power strip are unable to supply power anymore.

2. The power control mode via the computer host typically faces overloading issues. Once overloading occurs, the whole control apparatus may be damaged and deprived of control ability.

Thus it can be seen that the aforementioned conventional products still have many drawbacks and are not good in design, thus the aforementioned products need improvement.

The inventor considers improvement in view of the aforementioned drawbacks of the conventional power strip, and develops the present invention of power control apparatus for a power strip after a long term of research.

### SUMMARY OF THE INVENTION

The primary objective of the present invention is to provide a power control apparatus for a power strip. Since the signal lines of the USB connector are set in middle of the USB connector, the signal lines are free from bad connection even the USB connector is impacted.

Another objective of the present invention is to provide a power control apparatus for a power strip controlled by the computer host to supply power. The power control apparatus of the power strip is free from circuit damages caused by overloading.

The power control apparatus for a power strip can achieve the aforementioned objectives comprises at least one power outlet adapted to output AC power, the auxiliary power outlet being controlled by the control apparatus. The control apparatus comprises a USB connector, a signal isolation circuit, a voltage level simulation circuit, a filter circuit, a comparison circuit, a reference level generation circuit, an amplifier circuit, a relay, and an indication light. The USB connector comprises two power lines and two signal lines D+ and D−. The power lines are connected to all circuits of the control apparatus to deliver the power from the power line to the control apparatus for making the circuits inside the control apparatus operate normally when the USB connector is connected to the computer host. The signal isolation circuit is configured to isolate the signal lines D+ and D− to prevent abnormal signal transmission from the computer host via the signal lines D+ and D−. The voltage level simulation circuit is configured to provide a simulation signal to the computer host, and the computer host is configured to output signals to the filter circuit for filtering via the signal lines D+ and D− of the USB connector. After the filtering is accomplished, the signals are transmitted to the comparison circuit for being compared with the reference level signal generated by the reference level generation circuit. Once the outputted signal of the filter circuit is lower than the reference level signal, the comparison circuit transmits the signal to the amplifier circuit for being amplified to drive the relay, and then the AC power is delivered to each power outlet of the power strip. Therefore the auxiliary power outlets of the power strip are able to supply power.

These features and advantages of the present invention will be fully understood and appreciated from the following detailed description of the accompanying Drawings.

### BRIEF DESCRIPTION OF THE DRAWINGS

FIG. 1 illustrates a perspective view of the power control apparatus of the power strip of the present invention;

FIG. 2 illustrates a block diagram of the power control apparatus of the power strip of the present invention;

FIG. 3 illustrates a circuitry of the power control apparatus of the power strip of the present invention;

FIG. 4 illustrates the first embodiment of the power control apparatus of the power strip of the present invention; and

FIG. 5 illustrates the second embodiment of the power control apparatus of the power strip of the present invention.

### DETAILED DESCRIPTION OF THE PREFERRED EMBODIMENT

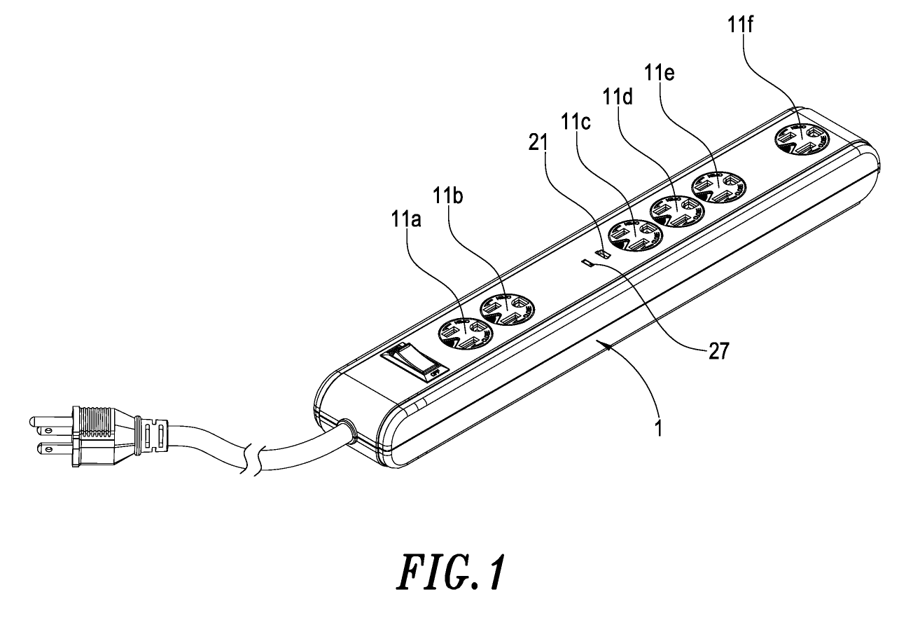

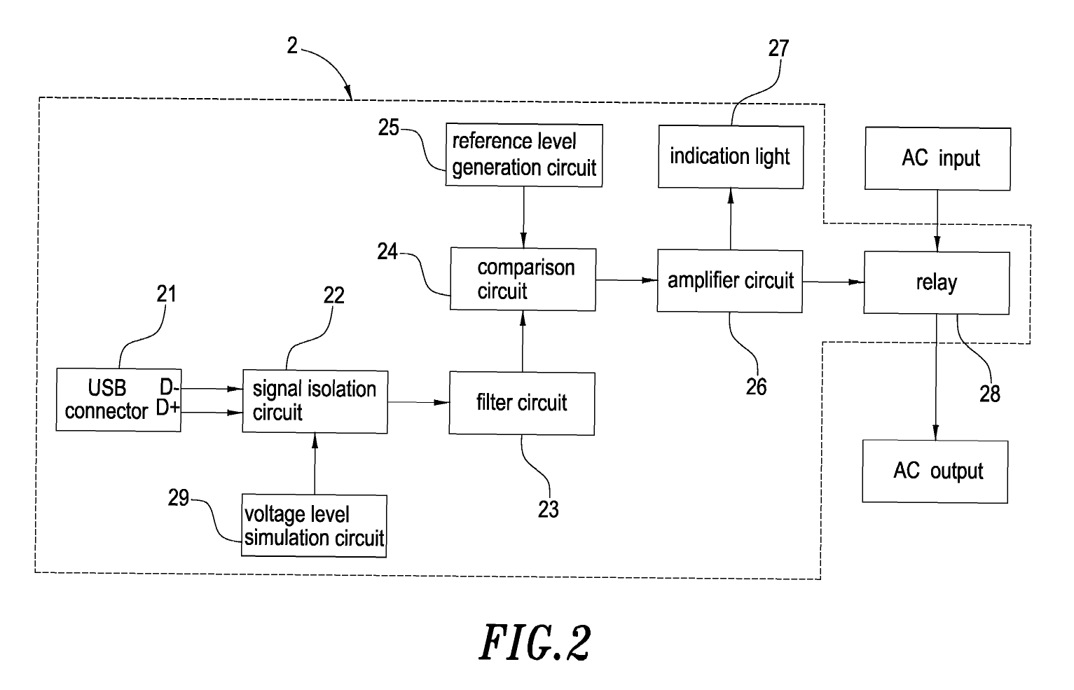

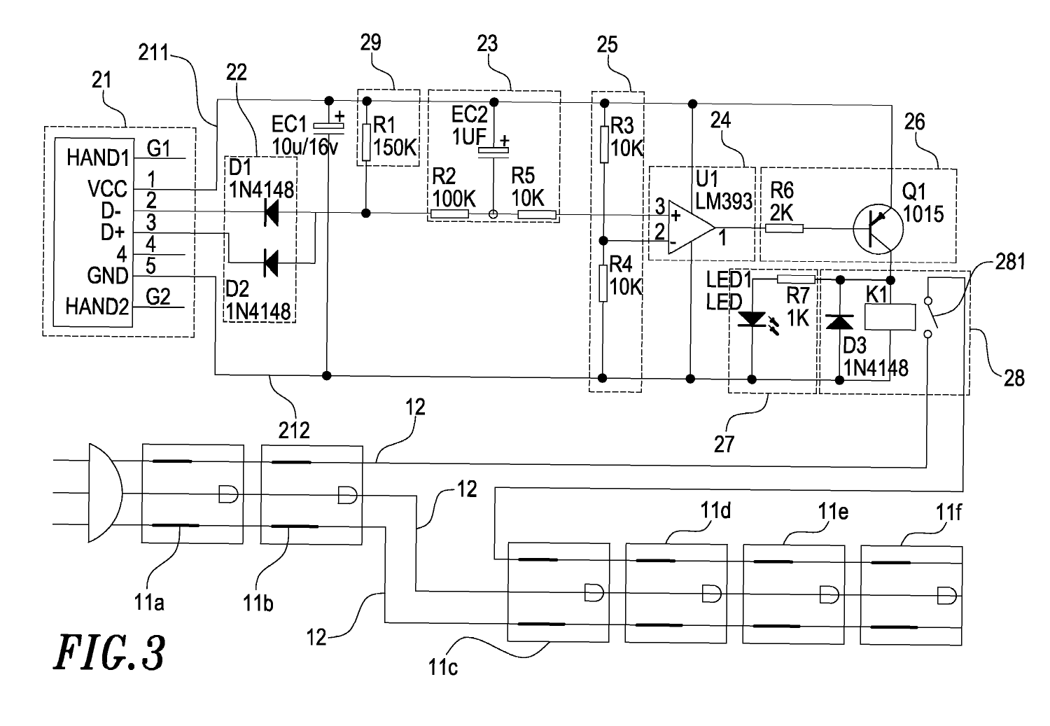

FIGS. 1 to 3 illustrate the perspective views of a power control apparatus for a power strip of the present invention. The present invention mainly comprises a power strip 1, and the power strip 1 is set with a plurality of power outlets 11a, 11b, 11c, 11d, 11e and 11f. At least the power outlets 11a and 11b are able to directly output AC power, and the auxiliary power outlets 11c, 11d, 11e, and 11f are controlled by a control apparatus 2 of the power strip 1 to supply power. The control apparatus 2 comprises the follows.

The control apparatus 2 comprises a USB connector 21. The USB connector 21 comprises at least two power lines 211, 212 and two signal lines D+ and D−. The power lines 211 and 212 are connected to all circuits of the control apparatus 2 to deliver the power from the power lines 211, 212 to the control apparatus 2 for making the circuits inside the control apparatus 2 operate normally. And the signal lines D+ and D− are connected to a signal isolation circuit 22.

The control apparatus 2 comprises the signal isolation circuit 22, the signal isolation circuit 22 is configured to isolate the two signal lines D+ and D− of the USB connector 21 to make the lines D+ and D− transmit signals to a filter circuit 23.

The control apparatus 2 comprises the filter circuit 23, the filter circuit 23 is configured to receive the signals from the isolation circuit 22, to filter the signals, and to transmit the signals to a positive terminal of a comparison circuit 24.

The control apparatus 2 comprises a reference level generation circuit 25. The reference level generation circuit 25 is connected to a negative terminal of the comparison circuit 24 to provide a reference level to the negative terminal of the comparison circuit 24.

The control apparatus 2 comprises the comparison circuit 24. The comparison circuit 24 is configured to compare the signal transmitted from the filter circuit 23 with the reference level. Once the signal transmitted from the filter circuit 23 is lower than the reference level, the comparison circuit 24 outputs a low-level signal to an amplifier circuit 26.

The control apparatus 2 comprises the amplifier circuit 26. The amplifier circuit 26 is configured to amplify the output signal of the comparison circuit 24 then transmit the amplified signal to an indication light 27 and a relay 28.

The control apparatus 2 comprises the relay 28. A switch 281 of the relay 28 is connected to the power wire 12 of the power strip 1 to isolate the AC power from being delivered to the auxiliary power outlets 11c, 11d, 11e, and 11f. When the relay 28 receives the signal from the amplifier circuit 26, the relay 28 automatically turns on the switch 281 for delivering the AC power to the auxiliary power outlets 11b and 11c to enable the auxiliary power outlets 11c, 11d, 11e, and 11f supply power.

The control apparatus 2 comprises the indication light 27. The indication light 27 generates light after receives the signal from the amplifier circuit 26, which means the auxiliary power outlets 11b and 11c of the power strip 1 are able to output AC power.

The control apparatus 2 comprises a voltage level simulation circuit 29 being connected to the signal isolation circuit 22. The voltage level simulation circuit 29 presents a resistance larger than the typical resistance of a computer host defined in the USB standard so as to make the computer host recognize the signals transmitted from the voltage level simulation circuit 29 and able to output signal to the control apparatus 2. Besides, once the USB connector 21 is not connected to the computer host, the voltage level simulation circuit 29 is configured to output a high-level signal to the positive terminal of the comparison circuit 24 via the filter circuit 23, so as to make the output signal of the filter circuit 23 larger than the reference level to inactivate the comparison circuit 24, therefore the auxiliary power outlets 11c, 11d, 11e, and 11f of the power strip 1 are unable to supply power.

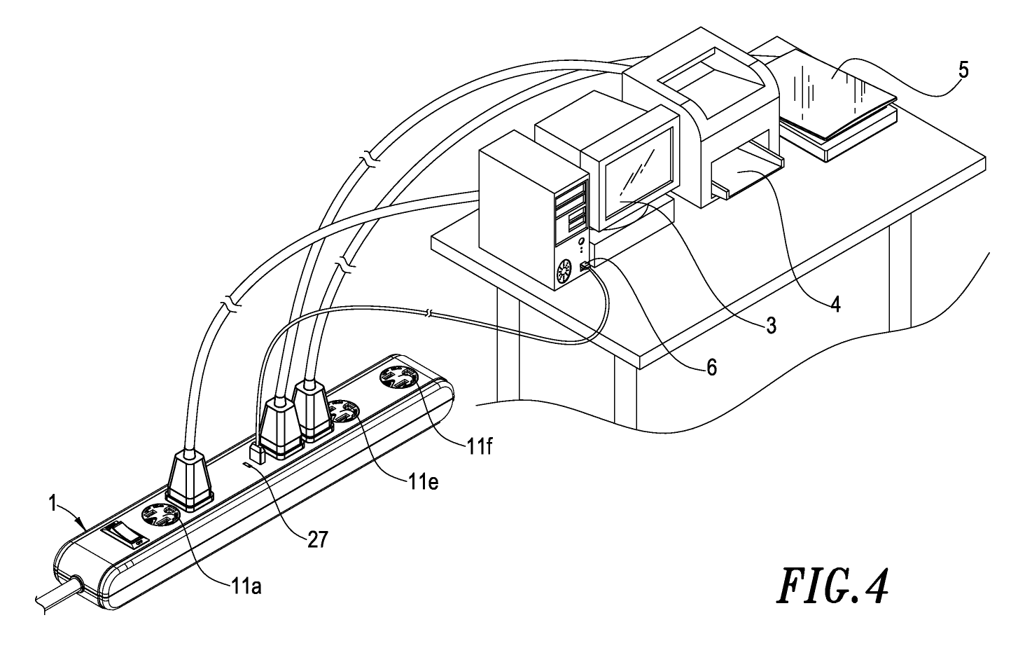

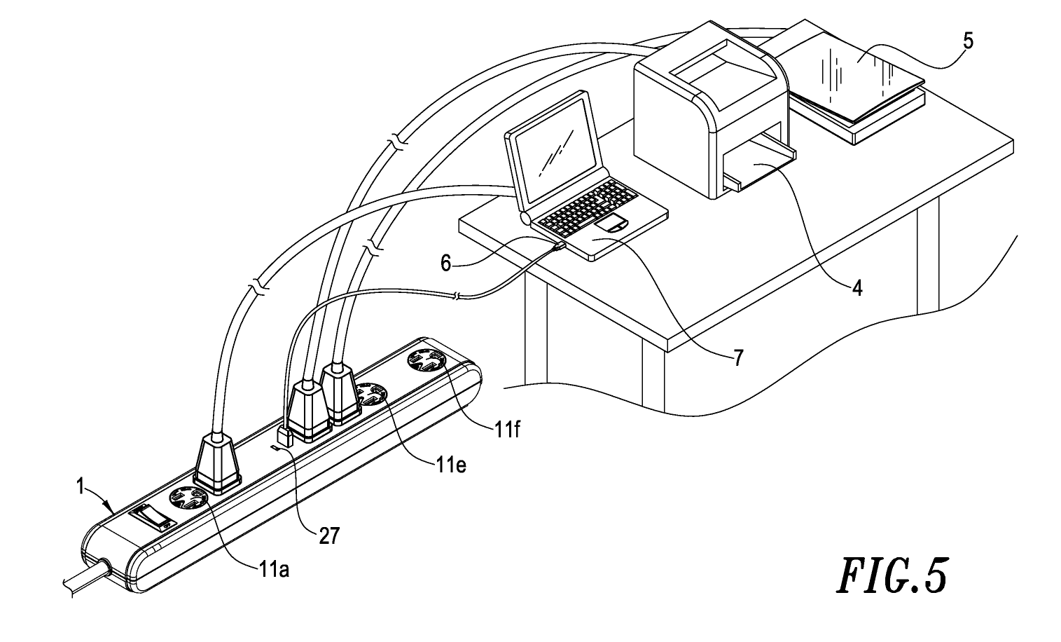

FIGS. 4 and 5 illustrate operation charts of the present invention. The power outlet 11b of the power strip 1 being able to directly supply power is connected to a computer host 3 or a notebook 7, and the power plus 11c, 11d of the power strip 1 being able to indirectly supply power are connected to peripheral devices such as printer 4 and scanner 5. When the computer host 3 is booted, a USB connection line 6 is adapted to connect the USB connector 21 and the computer host 3 or the notebook 7 together, in which the USB connector 21 protrudes outward the power strip 1. The voltage level simulation circuit 29 is configured to provide a signal to the computer host 3 or the notebook 7 to make the computer host 3 or the notebook 7 output signal to the signal lines D+ and D− of the USB connector 21. The signal isolation circuit 22 is configured to isolate the signal lines D+ and D−, so as to make the signal lines D+ and D− being able to transmit signal simultaneously to the filter circuit 23 for filtering. Then the signals are transmitted to the comparison circuit 24 and compared with the reference level. When the output signal of the filter circuit 24 is lower than the reference level, the comparison circuit outputs a low-level signal to the amplifier circuit 26 for being amplified to drive the indication light 27 and the relay 28. Thus the AC power is delivered to the auxiliary power outlets 11c, 11d, 11e, and 11f of the power strip 1 to make the peripheral devices such as the printer 4, the scanner 5 operate normally.

The power control apparatus for a power strip of the present invention, comparing with other conventional technologies, are advantaged as follows.

1. The power strip of the present invention is controlled by the signals retrieved from the computer host to supply power. Since the USB signal lines are set at middle of the USB connector, the signal lines are free from bad connection even the USB connector is impacted and slightly deformed.

2. The power control apparatus for a power strip of the present invention is controlled by the computer host to supply power. The power control apparatus of the power strip is not controlled by power and is free from circuit damages caused by overloading.

The aforementioned detail description is for explaining a particular embodiment of the present invention, and the embodiment is not applied to limit the present invention. The equivalent embodiment of modification after understanding the present invention shall be within the scope of the invention.

As aforementioned, the present invention is novel in technology and advantaged in many effects that the prior arts lack. The present invention conforms to the novelty and non-obviousness of patentability. Please the examiner carefully considering the application of the present invention and allowing the application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A power control apparatus for a power strip, the power strip comprising at least one power outlet adapted to output Alternating Current (AC) power, an auxiliary power outlet being controlled by the control apparatus, the control apparatus comprising:
a USB connector, protruding outward the power strip, comprising a power line and signal lines D+ and D−, in which the USB connector is configured to deliver power from the power line to the control apparatus for making circuits inside the control apparatus operate normally;
a signal isolation circuit, being connected to the signal lines D+ and D− of the USB, being configured to isolate the signal lines D+ and D− and output signals received by the signal lines D+ and D−;
a filter circuit, being configured to receive the signals from the signal isolation circuit and filter the signals for being transmitted to a comparison circuit;
a reference level generation circuit, being configured to provide a reference level to the comparison circuit;
the comparison circuit, being configured to compare the signals form the filter circuit with the reference level, and output a low-level signal to an amplifier circuit for being amplified when the signals from the filter circuit is lower than the reference level;
a relay, being configured to turn on a switch for delivering the AC power to the auxiliary power outlet after receives the signal from the amplifier circuit; and
a voltage level simulation circuit, being connected to the signal isolation circuit, in which the voltage level simulation circuit presents a resistance larger than typical resistance of a computer host or a notebook defined in USB standard so as to make the computer host or the notebook able to output signal to the signal lines D+ and D− of the USB connector.

2. The power control apparatus as claimed in claim 1, wherein the filter circuit is configured to output the signal to a positive terminal of the comparison circuit, and the reference level generation circuit is configured to output the reference level to a negative terminal of the comparison circuit.

3. The power control apparatus as claimed in claim 1, further comprising an indication light, in which the indication light is configured to generate light after receive the signal from the amplifier circuit to indicate that the auxiliary power outlet is ready to output AC power.

4. The power control apparatus as claimed in claim 1, wherein the voltage level simulation is configured to output a high-level signal to the comparison circuit via the filter circuit, so as to make the output signal of the filter circuit larger than the reference level to inactivate the comparison circuit.

5. The power control apparatus as claimed in claim 1, wherein the power outlet of the power strip being configured to directly output the AC power is for connection with the computer host.

6. The power control apparatus f as claimed in claim 1, wherein the power outlet of the power strip being configured to indirectly output the AC power is for connection with computer peripheral devices.
